(19) United States
(12) Patent Application Publication
(10) Pub. No.: US 2006/0061469 A1
(43) Pub. Date: Mar. 23, 2006

(54) Positioning system that uses signals from a point source

(75) Inventors: Edward Jaeger, Dover, MA (US); Neil Judell, Newtonville, MA (US)

Correspondence Address: WILMER CUTLER PICKERING HALE AND DORR LLP, 60 STATE STREET, BOSTON, MA, 02109, US

(73) Assignee: SkyFence Inc., Dover, MA (US)

(21) Appl. No.: 11/231,540

(22) Filed: Sep. 21, 2005

Related U.S. Application Data
(60) Provisional application No. 60/611,891, filed on Sep. 21, 2004.

(51) Int. Cl. G08B 1/08

(52) U.S. Cl. 340/539.13

(57) ABSTRACT

Systems for tracking, containing, and controlling moving objects such as vehicles, boats, airplanes, animals, and people use wireless RF or microwave signals to calculate position within a predefined boundary. The system has antennas in a location, and has processing for determining location either on a device on the mobile device or at a base station. The boundary can be arbitrary and can be learned during a set-up process.

### CROSS REFERENCE TO RELATED APPLICATION

This application claims priority from provisional application No. 60/611,891, filed Sep. 21, 2004, which is incorporated herein by reference.

### BACKGROUND

The system relates to a relative positioning system for a moving object.

A number of systems track objects using radio frequency (RF) signals. Commercial examples of these types of systems include Loran and Global Positioning Systems (GPS), although there are other smaller scale systems on the market. A common aspect of all of these systems is that the object being tracked has to be in communication with at multiple RF signal sources and/or receivers to triangulate a position.

Most of these systems, such as GPS, do not calculate absolute propagation time of a signal, but can only calculate relative arrival times. This limitation adds a variable to solved—the absolute propagation time, which can degrade the positional accuracy of these systems.

Most of these systems also rely on the monitored unit lying inside a space defined by the multiple transmission antennas. This requires an inconveniently large antenna array for the types of systems considered herein. The reason these systems require a large baseline is to improve the accuracy of tracking. Final tracking accuracy is directly related to propagation time accuracy. A system in which the monitored device lies outside an array of antennas requires a more accurate determination of propagation time.

In some systems, a base station modulates a carrier signal with a reference signal. The mobile device receives this signal, demodulates to obtain the reference, and then modulates a second carrier with this reference. This second signal is transmitted to the base. The base station demodulates this second signal, resulting in a delayed copy of the original reference. The delay is measured. This type of system has several weaknesses. Generally, the reference signal is sinusoidal (or nearly so). A sinusoidal reference has significant ambiguity—if the propagation delay is a multiple of the period of the waveform, the absolute propagation time cannot be unambiguously determined. Normally, such a system counts cycles, and so does not have this problem unless the signal is interrupted. Even a transitory interruption of the signal can result in positional ambiguity that cannot be resolved. Because the system is narrow-band, it is susceptible to outside interference.

Similarly, some systems measure signal strength and determine distance based on expected signal loss. These types of systems are susceptible to various environmental interference characteristics such as moisture in the atmosphere, and object present in the signal path that make this type of distance and location measurement ambiguous.

One application of the use of RF signals and tracking is for animal (usually a dog) containment. In one type of system, a wire is buried along a containment perimeter to carry RF signals that are received by a correction collar on the animal. As the collar receives the signal, varying intensity audio and electronic correction signals are applied. These types of systems are fixed based on the area enclosed by the wire. The containment area cannot be modified except by moving the wire that encompasses it. If, for any reason, the wire is broken, the system ceases to function.

In another method for animal containment, a local RF signal transmits radially from the transmitter. A collar placed on an animal receives this signal. Based on the intensity of the signal from the transmitter, the collar applies a correction signal to the animal as the animal moves from the transmitter. The intensity of the signal can be varied to cover a circular area with the transmitter at the center. The area covered can only be circular and the coverage area is limited.

Other methods using Global Positioning System (GPS) inputs have been used in animal containment and tracking systems. Due to the slow update rate and inherent inaccuracies of the GPS system, these solutions have not been commercially viable for the containment or control of moving objects. Standard GPS positions are accurate to numbers of meters and it takes multiple seconds to calculate a position. These signals are therefore not applicable to a moving object in a containment or control situation. Also, GPS satellite communication uses power such that its use is currently infeasible for portable applications that need to use batteries in these types of applications which require frequent position updates. Also, GPS satellite signals can fail to penetrate through heavy tree cover or inside buildings, rendering GPS systems useless for some applications.

Still other local positioning systems employ simple triangulation methods similar to the methods employed by GPS. These systems use multiple signal generators and/or receivers and antennae around the local area being covered. Because the antennas encircle or surround the local area being covered, this implementation can be burdensome since communication amongst the plurality of signal generators is required. Commonly, this entails the individual hardwiring (e.g., coaxial cable) of each signal generator to its respective antenna and to a base station. In addition, the tracking device must always be in contact with multiple signal generators and/or receivers to get a position fix. Accordingly, the time base inaccuracies between the signal generators also introduce an error into the system that translates into position inaccuracies.

### SUMMARY

Systems and methods are described for tracking, containing, and controlling (via a motion feedback loop) moving objects such as vehicles, boats, airplanes, animals, and people with spread spectrum wireless RF or microwave signals to calculate position within a predefined boundary.

One embodiment of a system includes a microprocessor or other processing device on a mobile device that is located on the object being tracked, contained, or controlled, and a local base station that communicates with the device over either licensed or unlicensed RF or microwave frequencies. Such a system preferably has all of the electronics required to collect and analyze spread spectrum RF or microwave signals to determine the speed, bearing, and position of the mobile device relative to a local base station. The system can perform local RF or microwave communication, local position calculation and can apply alarm, control, and correction outputs to the mobile object. The mobile device can have one or more of multiple output alarm, correction, and control capabilities, such as audio, visual, electric shock, steering, braking, etc. These output alarm and correction signals can be programmed to be activated with either an on/off signal or varying levels of intensity based on various conditions, such as object speed, object bearing, object size, or object position relative to the tracking/containment area. The device can communicate position and alarm conditions to the local base station over the local RF or microwave link, as well as other object status information and/or data collected from integrated sensors. The system is controlled by a microprocessor with non-volatile memory, allowing the system to store and change boundary positions, alarm conditions, waypoints for motion control, and all other operational input and output signals. Preferably, GPS would not be used for the monitoring or tracking relative to the base station, although GPS functionality could potentially be used in some manner.

In other embodiments, the base station performs most of the computations, while the mobile device can be small and power-efficient.

The latter type of system, with most of the calculations performed at the base station, is particularly useful for containing children, pets, or objects that would require a small and low-powered device. Typically, this embodiment would be used for a rather small number of mobile devices. The first embodiment referred to above would be more likely to be used for a large number of devices, such as a facility with a large number of pieces of mobile equipment.

In containment applications, the device continues to calculate position even when the wearer crosses the boundary and imposes no correction for coming back into the containment area as the wired RF systems do. The system continues applying correction/control signals and will not submit the wearer to the same alarm/correction signal as when it left the containment area when it re-enters the containment area.

The advantages of the method described in containment applications can include the fact that no wires need to be installed to mark the boundary, any shaped area can be defined, multiple containment areas with exclusion zones can be defined and stored, and varying levels of alarm conditions can be applied to the object being contained. Since the system uses low power RF signals, a battery can easily power the containment device for an extended period of time without the need for either replacement or recharging.

In each case, the base station is coupled to a number of antennas, preferably three antennas for two dimensional location or four antennas for three dimensional location, arranged in a manner such that the position can be uniquely determined. The antennas can be positioned anywhere within the containment area, including at the middle, at a periphery, or at any other location. It is desirable for convenience for the antennas to be close together, such as no more than a maximum of about 3 meters between each antenna, or more preferably, fewer, such as no more than about 2 meters or 1 meter, or less. With 1 meter separation between antennas at the base station antenna array, and a remote transmitter power of 10 milliwatts, a device can be tracked in an area of 2 acres with an accuracy greater than +/−six inches; for larger areas with the same configuration, the accuracy changes as the square root of the area. This means, for example, that antennas can be mounted in or on a structure in a number of configurations, such as, arranged as a right triangle. The antennas can thus take up much less area than the boundary of the containment and/or tracking area.

For containment applications, the systems can allow an arbitrary boundary to be defined and learned. For example, after setting a base station and antennas, a user can walk along a desired perimeter with a mobile device in a learning mode to define the perimeter based on signals taken at desired intervals. Similarly, in control applications, this method can be used to teach a route for an automatic guided vehicle to follow.

The systems and methods described here can have many uses, such as making sure that equipment, materials, children or pets do not leave a desired premises. The system when used for dog containment requires no buried wires, which impose costs on the user, can be inconvenient when the wire needs to be installed under a driveway or other solid surface, and fail to operate if the wire is broken.

Similarly, in many control applications, automatic guided vehicles follow a buried wire or solid track in a facility. These physical guidance tracks limit the ability to easily reconfigure laboratory, manufacturing, distribution, or other type of commercial space, or even just to add to or modify a vehicle's route.

The system can be further used for other types of monitoring, such as to keep track of the location of equipment. For example, at a loading dock, it may be desirable to track the location of each of a number of small vehicles, such as fork lift trucks. The systems thus have many applications whenever it is desirable to either keep a mobile device (which may be worn by a user) within a defined area.

Other applications can include monitoring individuals for safety reasons, such as military troops, police officers, medical personnel, or firefighters. For example, the location of an individual relative to a base station could be detected when searching through wreckage.

Still other control applications include automatic guidance of farm and landscaping equipment, cleaning equipment, cameras, military weapons, boats, or pick and place robots in distribution centers.

Another application for this system is for monitoring, tracking, and/or controlling moving objects in industrial and/or commercial settings. Examples of these types of systems include, but are not limited to inventory monitoring, camera control, robotic control, vehicle tracking and control, security, and proximity monitoring.

Other features and advantages will become apparent from the following detailed description and drawings.

### BRIEF DESCRIPTION OF THE DRAWINGS

FIG. 1 illustrates a mobile device and a base station.

FIG. 2 illustrates a plurality of mobile devices and a base station.

FIG. 3 illustrates how boundary points are used to create boundary lines which make up the perimeter of a containment area. By modifying one or more of the boundary points, or adding boundary points, the lines that define the containment are modified which modifies the perimeter of the containment area.

FIG. 4 illustrates the concept of exclusion zones within a containment area.

FIG. 5 illustrates the concept of alarm spaces.

FIG. 6 illustrates how waypoints are used for controlling a device and/or for calculating a route for an automated guided vehicle.

FIG. 7 is a block diagram of a passive mobile device.

FIG. 8 is a block diagram of a base station for use with the mobile device of FIG. 7.

FIG. 9 is a functional block diagram of mobile device that performs calculations at the device.

FIG. 10 is a functional block diagram of a base station for use with the mobile device of FIG. 9.

FIG. 11 is a block diagram of software functionality for the base station device.

FIG. 12 illustrates an embodiment with a camera and spotlight.

### DESCRIPTION

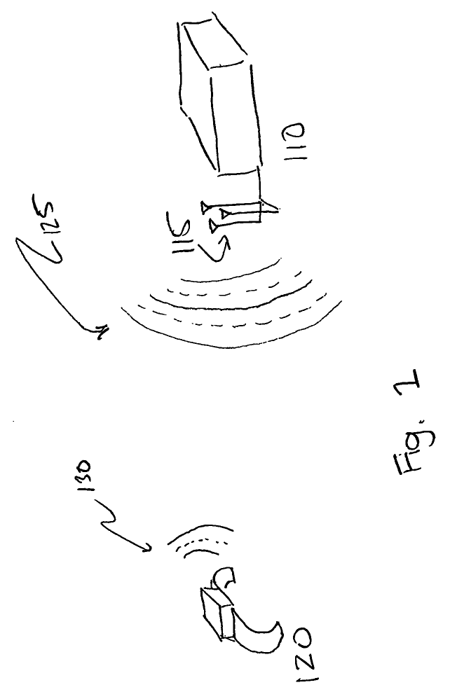

Referring to FIG. 1, a system according to one embodiment has two separate units, each controlled by a microprocessor. The first unit is a mobile device 120 that is attached to the person, pet, or object (not shown) that is being contained, tracked, or controlled. The second unit is a base station 110, which has a plurality of antennas 115 in a fixed configuration. The configuration may be different for distinct installations, but it remains fixed for a given installation. Base station 110 can communicate with mobile device 120 via RF or microwave signal 125.

Two configurations are described for this system. In a first configuration, mobile device 120 is small and power-efficient, and base station 110 performs the majority of the computations. Base station 110 has a single transmitter that provides a single spread-spectrum signal 125 that is received by mobile device 120. Mobile device 120 provides a frequency shifted return signal 130 back to the antennas at base station 110. Base station 110 receives return signal 130 from each of the receiving antennas 115. By accurately measuring the round-trip time for the signal to each antenna, base station 110 calculates the relative position of mobile device 120. A vector velocity can be determined by Doppler shift calculations of each of these signals, providing speed and bearing information.

Preferably, three antennas are used in order to uniquely identify the location of the object in two dimensions, and four to uniquely identify the location of the object in three dimensions. These antennas are preferably arranged in a triangle (and not in a straight line) and can be placed arbitrarily in or near the containment/control area to maximize signal coverage area. In one embodiment, the three antennas are separated by about one meter and can be located at the corner of a building, in a house, or between trees. A one meter spacing allows coverage of about 2 acres, while more area can be covered with more spacing, and with a smaller area, the antennas can be placed closer together. By not requiring that the antennas be set up at precise locations, it is easy for a user to set the system up, e.g., by mounting a base with three antennas on a corner of a building.

Base station 110 has boundary data stored in non-volatile memory. Base station 110 compares the position of mobile device 120 against the boundary position. If corrective actions are required, base station 110 encodes these actions into its spread spectrum signal. Mobile device 120 decodes these signals to perform the appropriate action, such as providing an alarm, or turning on or off a device. Similarly, a low data rate link from mobile device 120 to base station 110 can be implemented for communication purposes. This link permits data entry on mobile device 120 to be used to enter setup data into the system. With this configuration, only a few mobile devices would be used with each base station. Applications for this configuration include, but are not limited to, pet and child containment.

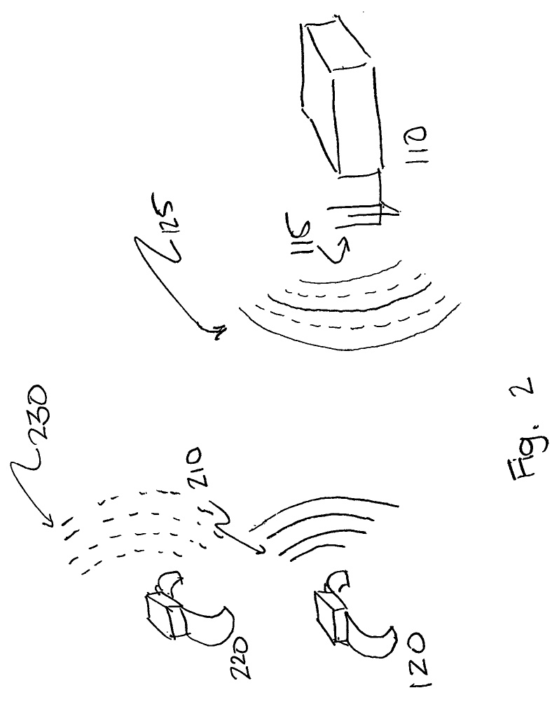

A second embodiment, depicted in FIG. 2, permits many (on the order of one thousand or more) mobile devices 120, 220 to be used with each base station 110. A unique identification system such as Code Division Multiple Access (CDMA) or other such system is used to implement distinct codes for each mobile device 120, 220. In the present embodiment, mobile devices 120, 220 transmit a unique spread spectrum signal 210, 230 based on the unique codes associated with each mobile device 120, 220. Base station 110 receives spread spectrum signals 210, 230 from mobile devices 120, 220 on each of its fixed antennas 115. Each of these signals received from each of the antennae is shifted in frequency (perhaps to a completely different radio frequency band) and retransmitted as shown by signals 125. Mobile devices 120, 220 receive multiple signals 125, and measure the round-trip time delay for each. Doppler shifts in the transmitted frequencies are also measured.

Using these data sets, mobile device 120 can use triangulation to determine its position relative to base station 110. Speed and heading may be determined from Doppler frequency shifts, tracking of position changes, or a combination of the two. Setup data is stored at mobile device 120, and corrective actions may be locally applied. A low data rate bidirectional link may be established between base station 110 and mobile devices 120, 220 for setup and status communications.

Position points are calculated as vectors and distances from the local base station. The position of the contained device is based on its relative position from the local base station. The device does not need to know absolute position with respect to its relationship with earth coordinates. It only needs to keep track of its position in space relative to the local base station. A real earth coordinate device, such as GPS or Loran, can be added to the base station to provide a real earth coordinate reference to the base station position, using the relative position calculations from the system as an offset from this fixed reference point.

The system includes setup and running modes of operation. The setup mode is used to set up operating parameters that define the operation of the device in the particular setting in which it is placed. Operating parameters include, but are not limited to, calibration of the individual receivers, the setup of a containment area's boundary points, exclusion zone boundary points, routing plans, alarm and correction conditions and severity, as well as all other operational parameters for the particular application that uses this technology.

Operational parameters can be downloaded to the device using a standard computing interface, such as RS-232, Ethernet, USB, IRDA, or IEEE-488. Parameters can be entered directly and manually into the device using an interface with LED's, small display screen, and button(s) or IR inputs controlled by the device's microprocessor. This manual method, using buttons or an IR link, allows the device to be moved along a route and/or to containment area corners, and notifying the device that its present position is a waypoint or corner by pressing a button or communicating via an IR or other type of “manual” interface. The positions that define the boundary points or routes are calculated the same way as the position data is calculated during normal operation, as direction and distance vectors from the base station. These points are stored in the either the base station's or the device's non-volatile memory and are available for operation until they are overwritten by a new set of boundary or route points. From these points, the lines that delineate the containment area (called boundary lines) or route points (called waypoints) are calculated and stored in memory on the device and/or at the base station.

The system thus allows boundaries to be learned. These boundaries need not be circular from an antenna, but can have a number of sides, and constitute a regular or irregular polygon.

Although the system can be used as both a containment device or as a position calculation system for tracking or as a feedback loop for motion control, it is helpful to break these two concepts into separate applications for ease of discussion.

Using the System as a Containment Device:

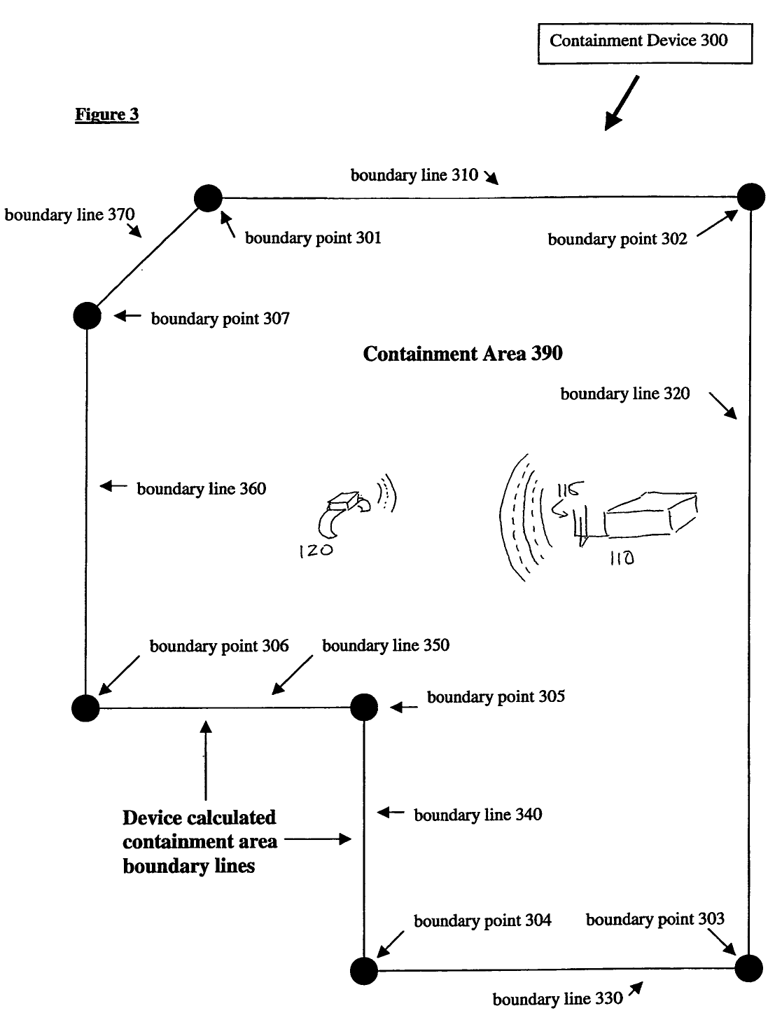

FIG. 3 represents an embodiment wherein the system is used as a containment device 300. The containment device 300 includes a base station 110, a mobile device 120, boundary points 301-307, and boundary lines 310-370. Boundary lines 310-370 define a perimeter that can be calculated by interpolating boundary points 301-307 that could be specified by a user.

If the device is being used as a containment device 300, it compares the position of mobile device 120 against predefined boundary lines 310-370 and sets appropriate alarm and/or correction condition(s) as mobile device 120 approaches the perimeter. In the case of a dog the action could be a small shock or an audio cue. There could be multiple and different actions, e.g., first an audio cue, and then a small electric shock, which can be followed by a series of intensifying shocks as the dog approaches the boundary. The area enclosed by the boundary lines is called the containment area 390. By modifying one or more of the boundary points 301-307, or adding boundary points, the lines that define the containment are modified, thereby modifying the perimeter of containment area 390.

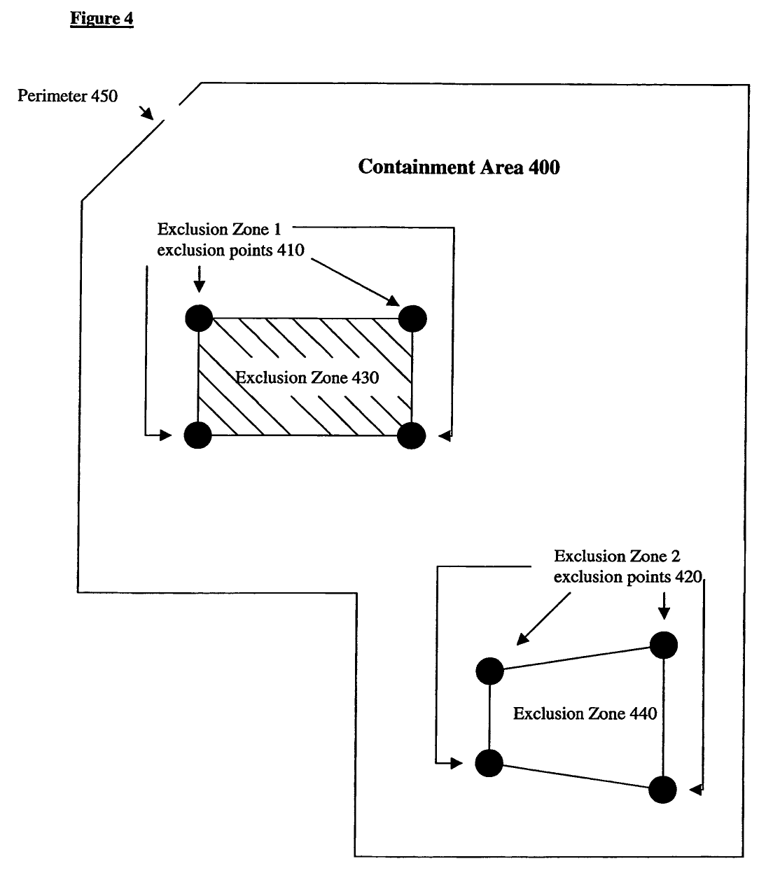

FIG. 4 demonstrates another embodiment with exclusion zones 430, 440 within a containment area 400. Mobile device 120 can be worn, e.g., by a dog or a person. Exclusion zones 430, 440 are areas within containment area 400 where the object is not allowed to enter. Alarm and correction signals near exclusion zone(s) 430, 440 are similar to the alarm and correction signals when leaving containment area 400. Exclusion zones 430, 440 are areas within the containment area 400 where the object is prohibited from entering. Exclusion zones 430, 440 are set up in a similar fashion to containment area 400, i.e., the user can move the device around a perimeter 450 of exclusion zone(s) 430, 440 and enter boundary points 410, 420 to define exclusion zones. Exclusion zone perimeters are calculated from points 410 or 420. There may be multiple exclusion zones 430, 440 within containment area 400, as is depicted in FIG. 4. These exclusion zones 430, 440 are set up for reasons that can include safety or interference of an object.

Points 301-307 in FIG. 3 that define the perimeter of containment area 400 as well as the points that define exclusion zone(s) 430, 440 within containment area 400 are stored in non-volatile memory on containment device 300. The containment device 300 stores and recalls multiple containment area boundary points corresponding to the boundary lines that make up containment area 400 in its non-volatile memory. Similarly, it stores points 410, 420 that make up the lines for exclusion zone(s) 430, 440 within the containment zone. The user can select between multiple sets of containment areas, and it can modify the boundary points that make up a containment area and add, modify, or delete exclusion zones within the containment areas so defined.

The parameters that control the alarm/correction output(s) from the device can be downloaded via a communication interface or directly entered into the device via a rudimentary device interface, such as, but not limited to, LED's, buttons, display screen, Bluetooth, and/or IR interface. These parameters vary from application to application, but are used to define the intensity of the alarm/correction outputs as the object approaches either the boundary or one of the exclusion zones 430, 440 within the containment area 400. These parameters can be either direct control parameters such as decibels for audio output, voltage levels for electric output, ramp values for braking force, distance from boundary to start the application of alarm/correction signals, minimum/maximum output limits, maximum object speed, etc. or they can be abstract parameters such as breed, weight, and age of an animal that are automatically correlated to the outputs(s) contained in the device for the particular application. Since the device is controlled by a microprocessor, the values and types of data can be programmed based on the application's requirements. These setup parameters are then stored in non-volatile memory on the device and used during device operation.

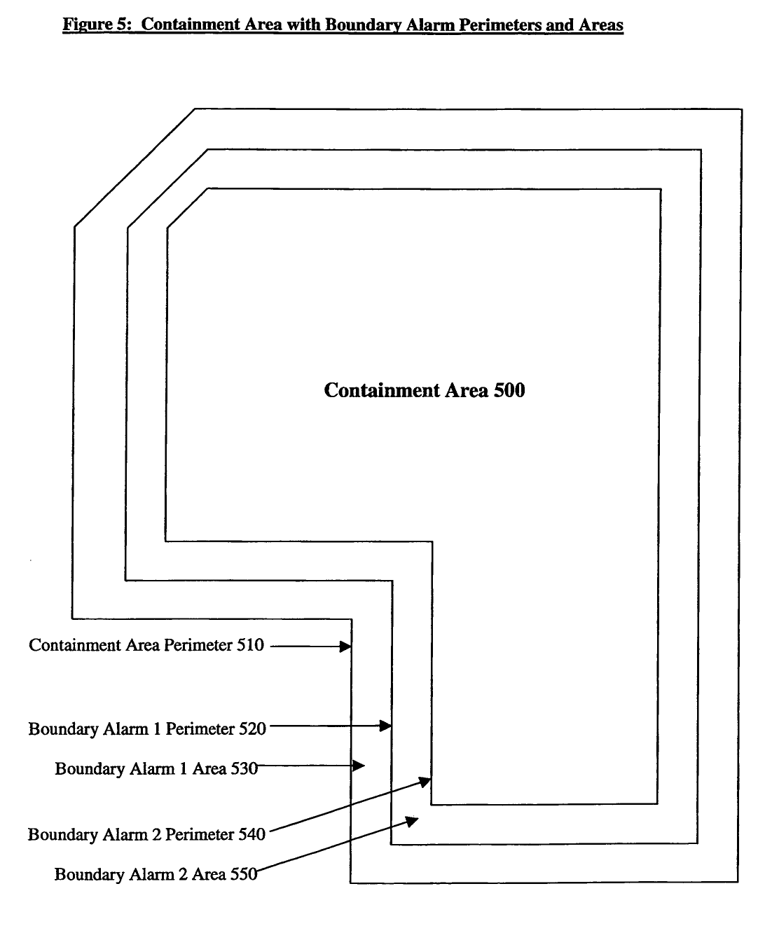

FIG. 5 exemplifies another embodiment in which various levels of correction are illustrated within the containment area 500. Two boundary alarm areas 530, 550 are illustrated. Boundary alarm 1 area 530, the area between the containment area perimeter 510 and the boundary alarm 1 perimeter 520, would be the area where the highest alarm conditions would be applied to the object. Boundary alarm 2 area 550, the area between boundary alarm 1 perimeter 520 and boundary alarm 2 perimeter 540, could be set up as an area where a different set of alarms from those associated boundary alarm 1 area 530 are to be applied or a different intensity level of the same alarms are applied. The number of boundary alarm areas used for an application is arbitrary, that is to say that they can vary from application to application and are only constrained by the amount of non-volatile memory available in containment device 300 (FIG. 3).

The system can be employed in multiple types of application environments. In some application environments, the boundary is considered a hard boundary, i.e., the object is controlled in such a fashion that it cannot leave the containment area or enter an exclusion zone within the containment area. These applications include manufacturing, distribution, and factory control applications. For example, a distribution center may have a system in which their forklift and clamp vehicles cannot be driven beyond a defined boundary. The “corrective action” in this case can include, e.g., braking and/or disabling the vehicle and/or providing an audible alarm.

In other application environments, the boundary is a soft boundary. This means that although the object receives alarm and correction signals as it approaches the boundary and alarm zones, these alarm and correction signals do not directly affect the object's motion, and the object can pass over the boundary lines. Examples of these types of applications include, but are not limited to, human and animal containment. In these types of applications, the device can be programmed to apply a different set of alarm and correction signals to the object when it is outside of the containment area to coax the object back into the containment area. Since the device knows the direction from which it is approaching the boundary, it can be programmed to not apply alarm or correction signals as the object approaches the boundary lines from outside the containment area, and only apply corrections as the device approaches the boundary from inside of the containment area.

Neither type of containment application environment changes the overall operation of the system. The system tracks position and administers the correct alarm and/or correction signal(s) based on the object's position relative to the containment area and exclusion zones. It is the application's responsibility to administer the correct type of signal under the correct circumstances.

During operation, the calculated device position is compared against the perimeter of the containment boundary and any exclusion zone perimeters. As the object approaches these perimeters, various levels of intensity of alarm signals are applied to the object being contained, based on the programming and setup of the device.

Although the position calculated by the device is relative to the position of a base station, actual earth coordinate device position can be calculated based on the Earth coordinates and orientation of the local base station. In this case the position is calculated as an offset from the base station's Earth coordinates.

Since the position of the device is constantly being calculated at a specific rate, the system is able to measure the velocity and acceleration of the object, and calculate the speed, bearing, and position of the object multiple times per second. This means that it is able to track an object that is moving tens and even hundreds of miles per hour accurately in a relatively small area. In addition to comparing the object's position against the boundary positions of a containment area and any exclusion areas in the containment area, the device is also capable of predicting when the object will come close to any of these boundary lines. This means that alarm and correction conditions can be applied to the object before it reaches the actual boundary line in order to account for excessive object speed.

Position Tracking and/or Motion Feedback for Control Applications:

The system can continuously calculate the position of the object relative to the base station. This data can be collected and used for data analysis to track the motion of an object in a defined space. Applications that require this type of data collection include, but are not limited to, security, manufacturing, retail, and distribution.

Since the position is calculated at a specific clock period, the change in position over time can be used to calculate velocity. Similarly the velocity difference over time can be used to calculate acceleration. These pieces of information can be used as feedback for motion control.

Since the position and heading are continuously calculated, the system can be used as an active feedback control system for camera, robots, or vehicles. The system can set up a group of waypoints that describe the route that the vehicle is supposed to follow. These waypoints are stored in non-volatile memory on the device or the base station, and are used during system operation. During operation, the device position is compared against the route defined by the stored waypoints, and control signals such as, but not limited to, acceleration, braking, and steering are applied to control the vehicles travel so that it follows the stored route.

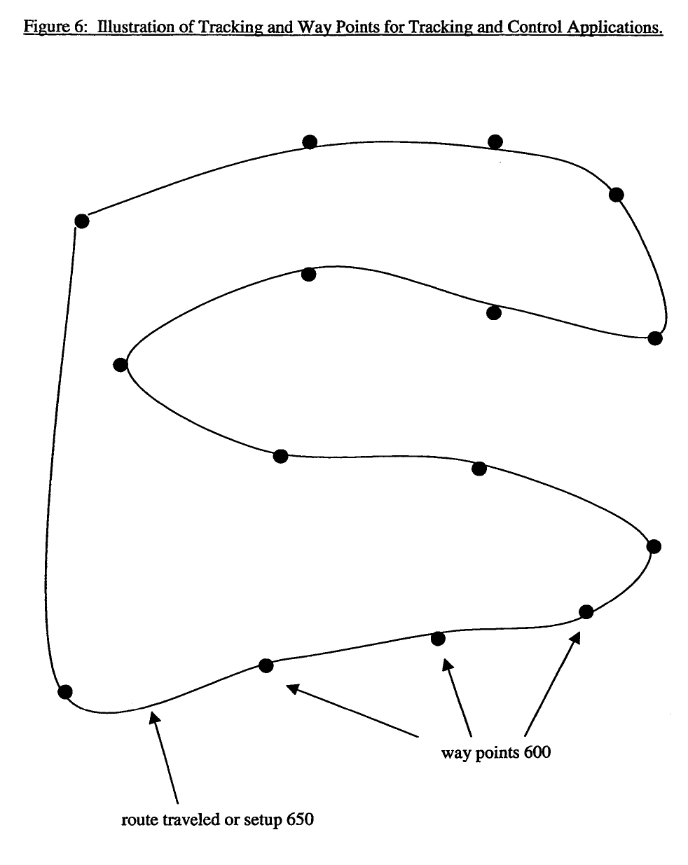

FIG. 6 illustrates an embodiment utilizing the concept of waypoints 600 for tracking and setup of routes 650 for feedback and control of automatic guided vehicles.

Since the device continuously updates position, it can also be used to collect position information and relate this information to physical layout information for tracking. Tracking applications include, but are not limited to, the tracking of consumers in retail settings, police/fire/military personnel in local settings, medical instruments and personnel in hospital settings, capital equipment and/or products in manufacturing and distribution settings, as well as tracking for various security applications, including military and emergency personnel tracking.

Similarly, the system can be used to control, in a semi-autonomous fashion, other objects such as lights, cameras, or military ordinance. These object can be integrated with the location system base station electronics to track a remote device attached which can be attached to an object. In fact, multiple objects can be integrated to track the remote device, for example, the lights and cameras for a video broadcast.

Again, the relative position can be converted into real earth coordinates as long as the position and orientation of the base station is known.

Receiver Calibration:

If actual position relative to a base station must be calculated (such as an application where the remote device is used to track firefighters inside a building), then calibration of the individual receiver round-trip delays is required, as each of these elements has a fixed delay associated with its electronics. One method of calibration uses a mechanical fixture located at a known position from the base station. The monitoring device is inserted into the fixture, round-trip delays are measured, and corrections are made for actual measurements. An alternative is to make one measurement, move the monitor a known amount, and repeat the measurement. Another method is to use an antenna and transceiver designed specifically for calibration.

Receiver calibration may not be necessary for applications in which tracking location is used solely for boundary comparison. As long as the boundaries consist of straight line segments, the boundary comparisons become simple linear combinations of the individual delays, and the calibration offsets cancel out of the solutions.

Configurations, Limits of Accuracy, Operations:

Technical characteristics of the system preferably include:
Single time base
Small antenna array with monitored area external to the array (this arrangement uses precise propagation time measurements)
Spread spectrum signals
Frequency shift for return signal generation

The system can be configured in different ways; the device can determine its position, or the base station can determine the position of the device and relay the position back to the device over the RF signal.

Regardless of configuration, one object of at least some embodiments is to accurately measure distance between a mobile device and each antenna of a base station. Once these distances are measured, a minimum error solution to determine the position of the mobile device 120 relative to the base station is performed. The overall accuracy and repeatability of this position measurement is governed by the accuracy with which the individual distance measurements can be made, and the geometry of the base station's antennas. The individual distance measurements are based upon a precise measurement of the round-trip propagation time of the spread spectrum sequence.

A single clock signal is used to calculate the round-trip propagation time of the spread spectrum sequence. The clock signal generator is located in the device which performs a majority of the calculations. For example, in the first configuration where the base station produces a spread spectrum signal that gets echoed back by the mobile device, the clock signal generator is located in the based station. The base station performs the timing/ranging calculations based on the clock signal including any necessary corrections. Corrections account for the amount of time that the echoing device (i.e., the mobile device in the above example) requires to process (e.g., frequency modulate) the signal are retransmit. The correction is measured as the amount of clock cycles the processor took to retransmit the signal, plus any analog latency that is either calibrated out of the system or put in as a constant delay correction.

The accuracy of the time measurement can be governed by either the thermal noise of the radio receiver or the accuracy of the measurement timebase. For reasonable battery powered implementations, such as a 10 mW transmitter over a 2 acre area, the propagation time accuracy will be governed by the time base. Measurements more accurate than 1 nanosecond are about the limit for current, inexpensive commercial components, while the use of thermal noise permits measurement more than ten times more accurate. This accuracy level corresponds to an individual measurement accuracy of about 1 mm. If the antennas are arranged in a right triangle, 1 meter on each side, a Dilution of Resolution (DOR) calculation indicates a worst-case relative position accuracy of 300 mm at the edge of a 2 acre lot.

For an animal containment application, where weight and power consumption should be minimized, the intelligence and signal processing power is provided at the base station. In this case, a digital spread spectrum signal is transmitted from one of the base station antennas. The remote device receives this signal frequency, shifts it, and retransmits it. The frequency shift is performed for two reasons. First, whatever equipment receives the signal from the remote device should be able to distinguish it from the original transmission. Second, if more than one mobile device is used, there should be a way to distinguish signals from each mobile device. Each mobile device employs a unique frequency shift, so the measurement space can use frequency division for multiple users. The base station receives the frequency-shifted signals on each antenna. The base station re-shifts these signals back to match the original transmission. A set of digital correlators is employed to measure the time lag between the original transmission and each frequency-shifted copy. While this description refers to a set of correlators, it should be understood that a set of correlators could mean a single correlator with appropriate multiplexing tp handle all the signals.

The mobile device can have a simple RF circuit using limited signal-processing capability. The number of mobile devices for a base station is limited both by the signal processing capability of the correlators at the base station and the number of possible frequency shifts. The frequency shifts should be large enough to avoid collisions between devices, but small enough to stay within the permitted radio frequency band. This typically limits the number of remote devices to a few tens of devices.

In one embodiment, the base stations transmits signals at frequency centered around 2.4 GHz. The mobile device receives the 2.4 GHz signal and modulates the received signal down to 900 MHz. The mobile device retransmits the signal at the modulated frequency of 900 MHz which is received by the base station.

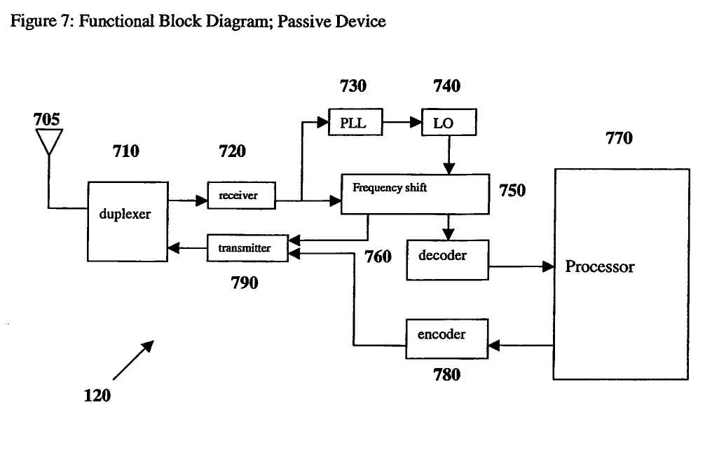

FIG. 7 depicts a mobile device 120 used in one or more embodiments in accordance with the first configuration, wherein the mobile device 120 modulates the received signal and retransmits the signal back to the base station. The mobile device includes a duplexer 710, a receiver 720, a phase lock loop (PLL) 730, a local oscillator (LO) 740, a frequency shifter 750, a decoder 760, a processor 770, an encoder 780, and a transmitter 790.

Referring to FIG. 7, an antenna 705 is connected to a duplexer 710, which prevents the transmitted signal from interfering with the received signal. If these signals are in separate RF bands, the complexity, weight and power requirements for duplexer 710 can be minimized. The broadband signal received from duplexer 710 is amplified by receiver 720. PLL 730 frequency locks to a sub-harmonic of the received broadband signal and drives local oscillator 740. The output of the local oscillator 740 and the output of the receiver 720 are mixed in frequency shifter 750 to provide a frequency-shifted output to the transmitter 790. Decoder 760 decodes any low bit-rate messages from the base station. Encoder 770 is employed to add status information, if any, going back to the base station. Processor 770 processes received and transmitted messages.

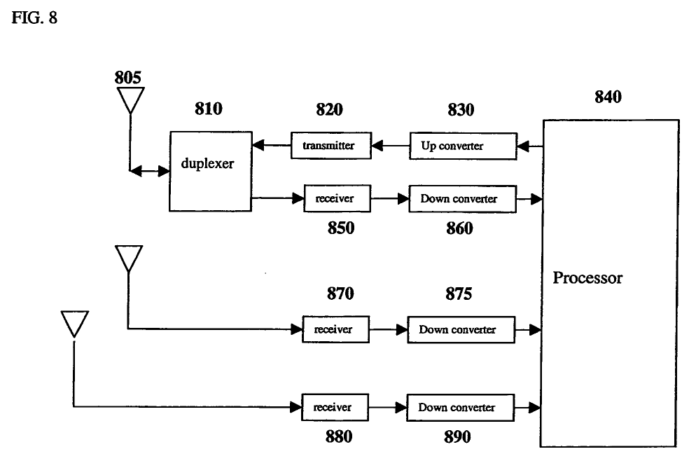

FIG. 8 is a logical system diagram of a base station according to another embodiment for use with on or more mobile devices. Within the present embodiment which is in accordance of the first configuration, the majority of the computing is performed by the base station. Referring to FIG. 8, duplexer 810 permits the first antenna 805 to be used to process both transmitted and received signals without the transmitted signal interfering with the received signal. If separate RF bands are used for these functions, then the weight, power usage and cost of duplexer 810 can be minimized.

Processor 840 generates the baseband spread spectrum signal to be transmitted. Upconverter 830 frequency translates this signal to the desired frequency band. The RF signal is amplified by transmitter 820, and sent to the antenna 805 via duplexer 810.

Receivers 850, 870, and 880 receive and amplify the returned, frequency-shifted spread spectrum signals. These RF signals are frequency-shifted to baseband by downconverters 860, 875, and 890. The outputs of the downcoverters 860, 875, and 890 are sent to processor 840. Processor 840 uses software correlators to determine coarse ranging of the spread spectrum signals. Spread spectrum correlators resolve the signal to less than a single cycle of the clock signal. After correlation, Doppler phase measurement algorithms are employed to make fine ranging measurements. Doppler phase measurements are taken by comparing the frequency/phase of the sent spread spectrum signal (i.e., reference signal) to the received spread spectrum signal using a phase lock loop (PLL) circuit. The Doppler phase measurements algorithms resolve the accuracy down to a millimeter/sub-nanosecond level. Position solutions, boundary comparisons and other status algorithms are performed by processor 840.

In either of these architectures, a low data rate modulation and demodulation scheme may be added to the spread spectrum to permit information to be transferred between the mobile devices and the base station. These may reflect button presses at the mobile device, position updates, corrective control signals, optional sensor data transmission, unique remote device identifier, or other direct communication data. The relative position methodologies employed in these architectures are essentially the same as those employed for GPS. Differences between this technique and GPS include: the reference antennas do not move (fixed base station instead of satellites); instead of attempting to resolve an unknown clock (GPS), this architecture directly measures delay by correlating with the reference system transmitted signal; instead of a very large baseline for the reference antennas (GPS), a baseline far smaller than the covered area is used. This latter feature of small baseline means that a more accurate individual delay measurement is desired for accuracy equivalent to GPS. This accuracy is provided by self-referencing the clock, i.e., the transmitting source itself measures the two-way propagation delay rather than the receiver inferring it from multiple sources.

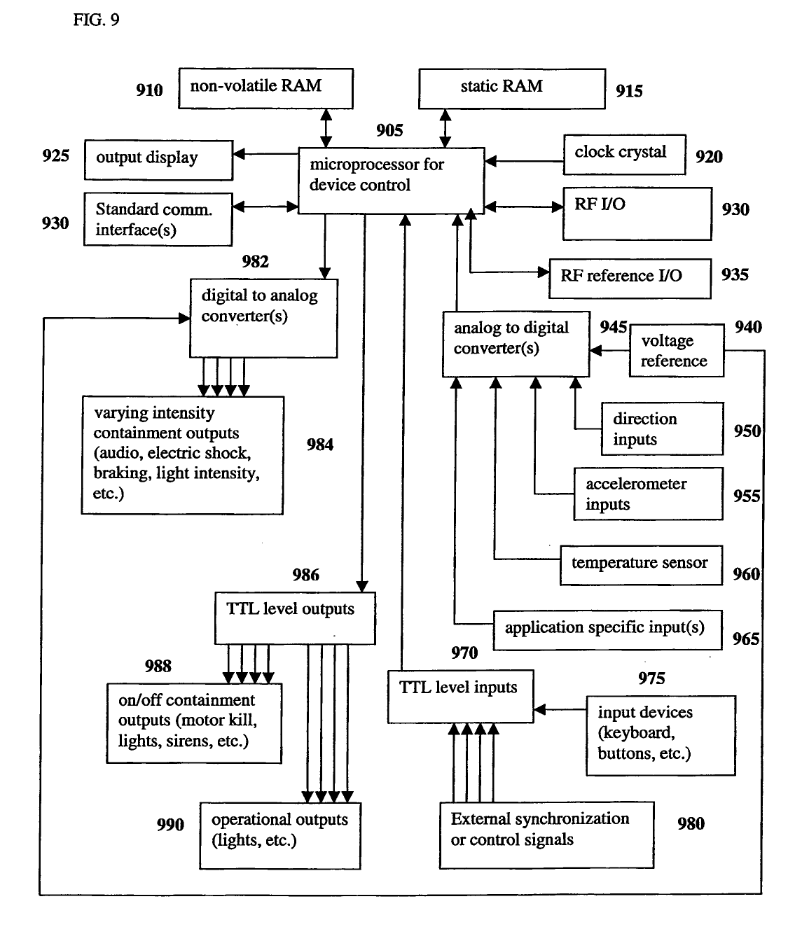

FIG. 9 illustrates an embodiment according to a second configuration. FIG. 9 depicts a mobile device with significant processing capability, typically without much processing by the base station. Referring to FIG. 9, the device is controlled by a microprocessor 905 with an optional Inertial Navigation System (INS). This optional INS can be used either as a substitute for the RF location system in the event that the RF signal is lost, or to augment the RF location technique. Microprocessor 905 should be fast enough to handle inputs from an accelerometer 955 and direction sensors for each axis in two or three dimensional space, convert these inputs into relative coordinates, integrate these signals over time to calculate speed, factor in the converted and scaled direction inputs to calculate a speed and direction vector, and integrate the speed again to calculate position. It also should have enough processing power to communicate with the spread-spectrum tracking system to receive the position information and fix the device position from the inputs, convert that position into the same units as the INS position and perform the position error correction algorithm. Microprocessor 905 can suspend full active position tracking while it is in setup mode, so that this lower level computing task does not factor into the calculation of microprocessor speed.

The desired accuracy for the application can be a factor in sizing the processing power required. The speed and accuracy of the microprocessor 905, therefore, is related to the type of application that the device is being used for. The positional accuracy and tracking accuracy require a combination of faster sampling rates for the (INS) sensors and/or higher accuracy for calculations, and/or tighter control of filtering algorithms which relate to microprocessor word length size (8, 16, 32, 64, 128, or higher) and more stringent filtering of input parameters, interim calculations, and error factors, the maximum speed of the object, the relative size of the containment area, the dynamic range of distance resolution, and other items all factor into the specification of the microprocessor architecture, clock speed, word length, etc.

The device has an amount of Non-Volatile Random Access Memory (NVRAM) 910, as required by the application, to store both the application code and user defined setup parameters relating to correction signal outputs and containment area and exclusion zone(s) boundary points. The amount of NVRAM 910 can vary from application to application based on the size of the device code and the number of setup parameters. The NVRAM 910 can be integrated with the microprocessor.

The device has Random Access Memory (RAM) 915 to run the program and store interim factors for its tracking algorithms. The amount of RAM 915 can vary from application to application based on the size of the device code as well as the memory requirements of the tracking algorithms. The RAM 915 can be integrated with the microprocessor.

A clock crystal 920 supplies the device with its reference frequency. The speed of the clock crystal 920 depends on the required speed of the device processor, which can vary from application to application.

An optional output display 925 for the device will generally be a small LCD display with varying display properties ranging from single line LCD displays through small back lit LCD screens. The display is not integral to the operation of the device, and may not be required for all applications. The display requirements vary from application to application.

An RF I/O section 930 has the electronics necessary to encode and modulate status information back to the base station as well as to demodulate and decode control information sent by the base station.

An RF reference I/O 935 receiver and transmitter has electronics required to deal with the frequency shifting and retransmission for propagation delay determination.

A voltage reference 940 is a stable reference voltage for both analog to digital converters 945 and digital to analog converters 982 on the device. The reference voltage 940 is needed by the analog to digital converter(s) 945 to scale the input voltages into their digital representation. The reference voltage 940 is required by the digital to analog converter(s) 982 to scale the output voltage from its digital representation for the output apparatus.

Analog to digital converter(s) 945 convert real world analog signals into their digital representation for use by the device processor in the navigation/positioning algorithms. There may be one or more analog to digital converter(s) 945 on the device. Real world analog signals are either directly connected to the converter through their sensor and signal conditioning hardware. Multiple signals may be multiplexed to a single analog to digital converter 945, with the input signal chosen via hardware and/or software control. The analog to digital converters may be integrated with the microprocessor, in some implementations.

In the case where an optional Inertial Navigation System (INS) system is integrated with the RF location system, direction inputs 950 are a series of two or three inputs. There is one input for each axis being measured. These direction inputs measure the direction of the object relative to earth coordinates. The input is a voltage that is fed to analog to digital converter 945 for conversion into a digital representation of the signal intensity. These inputs include gyroscope, magnetic compass, altimeter, or other sensors which measure the object's directional orientation.

Also with an optional INS system, accelerometer inputs 955 are a series of two or three inputs with one input for each axis being measured. The signal on each axis is a voltage proportional to the acceleration of the containment device along each axis. The input is a voltage fed to analog to digital converter 945 for conversion into a digital representation of the signal intensity. The system can have an accelerometer associated with each directional axis it is measuring, or can use one or more multi-axis accelerometers.

Temperature input 960 is an input to the system to compensate for system drift due to large shifts in temperature. For highly accurate systems, this input is used for running a self calibration sequence on the device to correct for any temperature drift in the sensor inputs. For systems that do not need to be as accurate, this temperature input can be omitted.

The application specific input(s) 965 are specific inputs for the device based on the application that is using the device. These inputs are not necessarily required for the tracking or positioning functions of the device, but can have a number of uses, such as for power level monitoring, brake lockup feedback loops, etc. There can be more than one application specific input for the device based on the requirements of the application.

The TTL (transistor to transistor logic) inputs 970 are discreet logic level, on/off signals for the application. This is where discreet button or keyboard devices used for device setup (boundary point entry, alarm condition entry, etc.) 975 are interfaced into the system. Also, depending on application requirements, external synchronization or control signals 980 are interfaced to the device through these TTL inputs. The TTL inputs may be integrated with the microprocessor, in some implementations.

The digital to analog converter(s) 982 convert digital representation of alarm and correction signals to their real world analog output apparatus 984. There may be one or more digital to analog converter(s) on a device. The output of the converter may be multiplexed to multiple output apparatus via hardware and/or software control. By having the alarm and control outputs go through a digital to analog converter, the intensity level can be varied under program control.

The TTL outputs 986 are discreet logic level, on/off signals for the application. Discrete on/off containment outputs (motor kill, lights, sirens, etc.) 988 are interfaced into the system at outputs 986. Also, depending on application requirements, operational outputs such as indicator lights 990 are interfaced to the device through these TTL outputs.

Depending on the application, standard computing communication interfaces 930 can be interfaced to the device. These interfaces include, but are not limited to, RS-232, Ethernet, USB, IRDA, and IEEE-488.

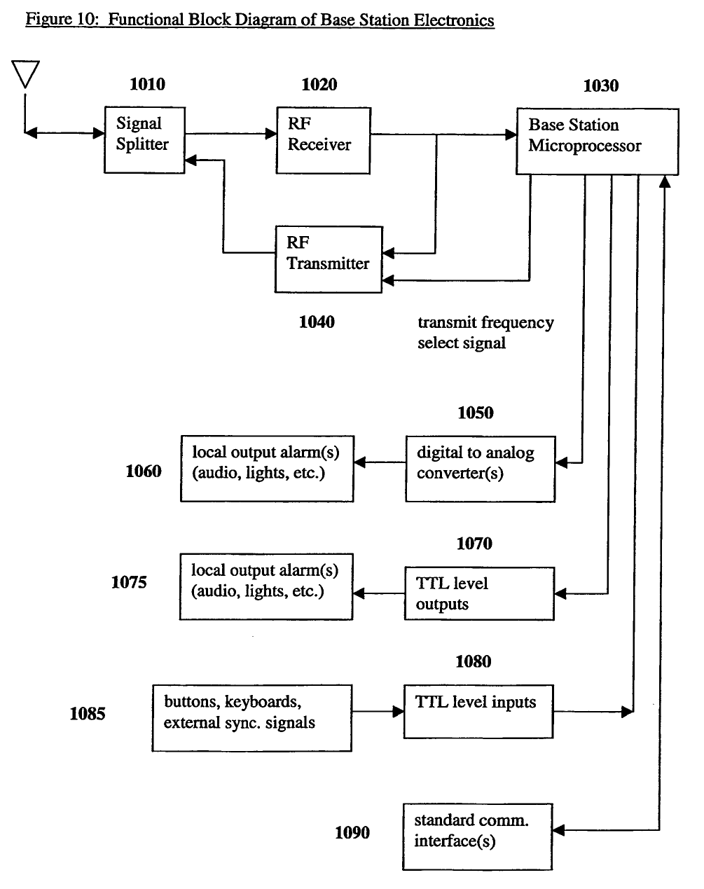

FIG. 10 is another embodiment of a base station for use with a mobile device that has significant processing capabilities, such as the mobile device of FIG. 9, in accordance with the second configuration. Referring to FIG. 10, the base station electronics can be fairly simple and mainly an RF transmitter/receiver that is used as a reference point for the containment device. No position calculations are needed using the base station electronics in this embodiment.

The base station is controlled using a microprocessor 1030. This microprocessor controls the transmit frequency selection for the return message to the containment device. It is also responsible for controlling any optional local alarm signals. Local alarm signals can take a number of forms. One approach is illustrated using digital to analog converter(s) 1050. These local output alarms 1060 can include, but are not limited to audio output, lights, etc. Another form of local alarms is a more traditional on/off control from a TTL level output 1070. These on/off alarm signals can include, but are not limited to, audio, lights, external synchronization signals, etc. 1075.

A set of optional TTL level inputs 1080 to the base station can be provided. Examples of TTL level inputs include, but are not limited to, buttons, keyboards, and external synchronization signals 1085.

Depending on the application, standard computing communication interfaces 1090 can be interfaced to the device. These interfaces include, but are not limited to, RS-232, Ethernet, USB, IRDA, and IEEE-488.

System Software

The system software is the combination of the software that controls the device and the software that controls the local base station. The actual position calculation can take place in either device, with the position result relayed to the other device via the RF link.

The system software can be modified at either the device or base station to support whatever alarm, control, communication, or display options are necessary for the particular application where the system is used.

The software that controls the RF range finding algorithm is the main application. This software is responsible for:
Sending and receiving RF messages between the base station and the device at the specified rate
Running the correlators to determine two-way propagation delay between the mobile device and the base station antennas
Performing Doppler phase measurements to calculate propagation delay subrange
Calculating the distance and direction vector from the base station to the device
Calculating the bearing, speed, and acceleration of the device relative to the base station position
Calculating vectors for position calculation and input to estimation algorithm for motion control
Calculating boundary lines from boundary points (containment and exclusion zones)
Determine intensity of variable alarm and correction signals based on system setup
Comparing current position against containment perimeter, and setting the specified alarms and control signals as the containment device position approaches the boundary alarm perimeter(s) and the containment perimeter based on the configuration of the application
Comparing current position against exclusion zone perimeter(s), and setting the specified alarms as the containment device position approaches the exclusion zone alarm perimeter(s) and the exclusion zone perimeter(s) based on the configuration of the application
Comparing current position against route calculation and setting appropriate acceleration, steering, braking and other motion parameters based on location feedback and waypoint route information.
Reading all TTL level inputs for setup and synchronization
Writing all TTL level outputs for alarms, operational outputs, synchronization signals, etc.
Reading all analog to digital converters for optional sensor inputs.
Writing all digital to analog converters for alarms, operational outputs, synchronization signals, etc.
Reading and storing containment boundary and exclusion boundary points
Reading and storing alarm conditions and distances from boundary perimeter(s) to alarm perimeter(s)
Reading application specific inputs and making determinations as to system operation based on these inputs

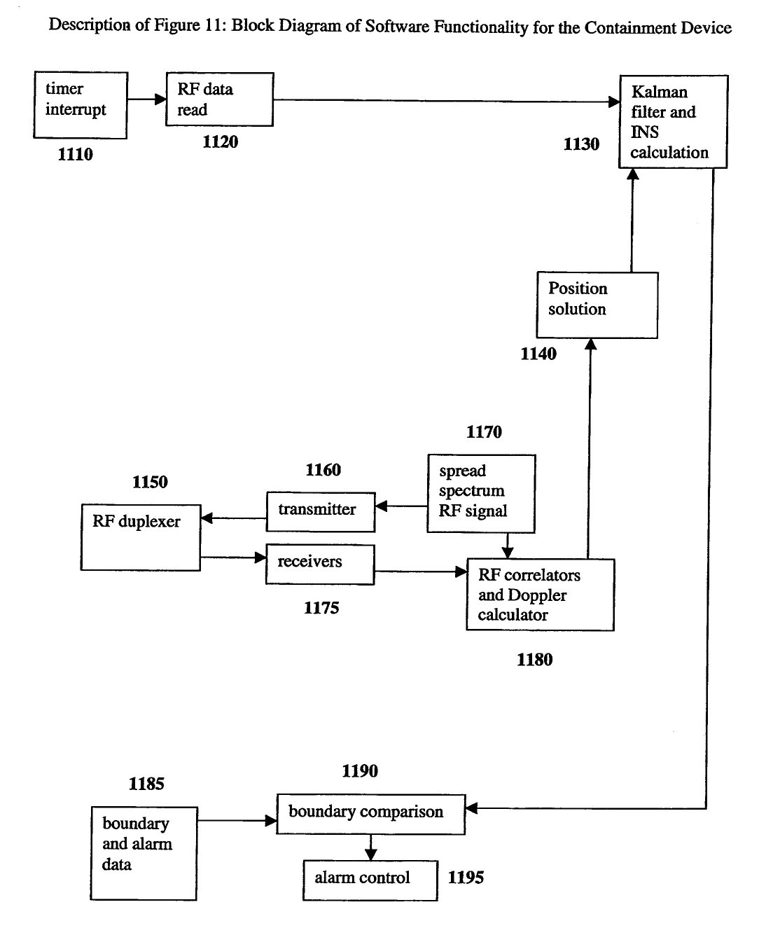

A block diagram that describes the operation of the main communication and location software is presented in FIG. 11.

The timer interrupt 1110 initiates the reading of the optional inertial navigation sensors data and the RF stream 1120.

The scaled INS sensor values are then passed to a Kalman filter and INS calculation module 1130. This is the main calculation engine in the device. It takes the inputs from the sensors and calculates the velocity, heading, and position of the object. It also takes the output from the position solution 1140 to correct for the long term drift in the INS algorithm.

The spread spectrum RF signal generator module 1170 creates the spread spectrum RF message. It passes this message to the RF transmitter module 1160 so it can be sent through the RF duplexer 1150. The delayed and frequency shifted messages from the mobile device are received via the RF duplexer and passed through the receiver modules 1175 and are sent to the RF correlators and Doppler calculation module 1180. The RF correlator and Doppler calculation module 1180 receives both the original RF signal and the response messages and correlates these two messages to determine the distance the containment device is from the base station. This data is then fed to the position solution algorithm.

For containment applications, the boundary comparison module 1185 reads the boundary and alarm data 1190, and compares the heading, velocity and position of the object against the boundary positions and alarm zone information stored in the system. It then sends a message that contains the alarm state(s) and intensity values to the alarm control module 1195. The alarm control module controls the alarm and control outputs of the device.

For control applications, the route comparison module 1125 reads the route and motion control data 1115, and compares the heading, velocity and position of the object against the waypoints and motion control information stored in the system. It then sends a message that contains the direction, speed, and acceleration values to the motion control module 1135. The motion control module controls the motion and control outputs of the device.

Additional software at the base station is responsible for communicating over any standard computing communication link, if applicable.

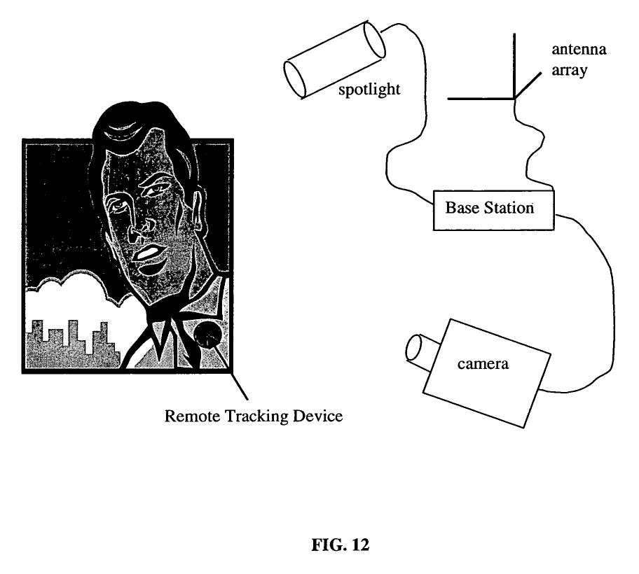

Referring to FIG. 12, the system can be integrated with a camera and a spotlight with integrated mechanisms for focus and aim. The base station tracks the remote device that has been attached to the subject being filmed, and either directly controls the mechanisms that aim and focus the spotlight and camera or send a series of messages to the camera and spotlight controllers that contain relative location information.

While certain functions have been described as being software functions, these can be implemented in software with general purpose processing, or they could be implemented with specific purpose processing, such as with array logic, or through applications of specific integrated circuits. In short, what is described here as being implemented in software can also be implemented in hardware or in a combination of hardware and software.

Having described certain embodiments, it should be apparent that modifications can be made without departing from the scope of the appended claims.

What is claimed is:

1. A system for tracking one or more mobile objects with receivers in a monitored area comprising:
a base station including:
a plurality of antennas encompassing an area smaller than the monitored area,
a single transmitter for transmitting a spread spectrum signal,
the antennas receiving a signal from mobile objects,
one or more correlators for determining a delay time between each received signal and the original spread spectrum signal,
the base station determining relative position of the mobile object to the base station.

2. The system of claim 1, wherein the spread spectrum signal is a direct sequence spread spectrum signal, wherein the antennas receive frequency-shifted signals, the base station further comprising one or more frequency shifters for converting the received signals back to the transmitted original direct sequence spread spectrum domain.

3. The system of claim 1, wherein the plurality of antennas are implemented as one antenna with a multiplexer.

4. The system of claim 1, wherein the base station includes memory for storing a representation of a set of boundaries for the objects being tracked.

5. The system of claim 4, wherein the base station compares a determined position of the mobile unit with the boundary and provides an action including one of an alarm or corrective signal in response.

6. The system of claim 5, further comprising logic to determine the action to be taken based on whether the proximity of the mobile object to the boundary, and whether mobile object is inside or outside boundary.

7. The system of claim 6, further comprising a receiver mounted on the mobile object, the receiver receiving signals from the base station, including one of an audio alarm, a signal to disable the object, and/or an electric shock.

8. The system of claim 1, wherein the base can provide different actions, depending on proximity to the boundary and/or whether the mobile object is inside or outside the boundary.

9. The system of claim 1, wherein the base station has a learning mode that allows a user to define a boundary by moving a receiver to locations on a perimeter of the boundary and identifying to the base station locations along the boundary, the base station storing information about the boundary.

10. The system of claim 4, wherein the base station stores exclusion zones within the boundary, the exclusion zones being treated as area outside of the boundary.

11. The system of claim 1, wherein the antennas are no more than 3 meters apart and arranged in a configuration other than a straight line.

12. The system of claim 11, wherein the antennas are no more than 1 meter apart.

13. The system of claim 1, further including one or more phase lock loops and Doppler phase measurement logic to provide subranging.

14. The system of claim 1, wherein the spread spectrum signal is a direct sequence spread spectrum signal.

15. A method comprising using the system of claim 1 for monitoring position and providing corrective action based on the position of the mobile object.

16. A method comprising using the system of claim 1 for continuously tracking and controlling movement of the mobile object.

17. The method of claim 16, wherein the base station provides signals to cause the mobile object to move in a desired manner.

18. The method of claim 17, wherein the base station receives, from the mobile object, continuous motion feedback for control of mobile objects.

19. The method of claim 18, wherein the base station has memory for storing a representation of a route to travel.

20. The method of claim 19, wherein the base station provides signals to indicate to the mobile object direction, motion, and stopping.
